(19) United States
(12) Patent Application Publication
(10) Pub. No.: US 2025/0303773 A1
(43) Pub. Date: Oct. 2, 2025

(54) ADJUSTABLE BOOK CLAMP

(71) Applicant: Guangzhou Youxiang Cultural Supplies Co.,Ltd, Guangzhou (CN)

(72) Inventors: Huaqian Liang, Guangzhou (CN); Hao Shi, Guangzhou (CN); Cong Huang, Guangzhou (CN)

(21) Appl. No.: 19/232,715

(22) Filed: Jun. 9, 2025

(30) Foreign Application Priority Data
Sep. 24, 2024 (CN) 202422339777.2

(51) Int. Cl. B42D 9/00

(52) U.S. Cl. CPC B42D 9/00

(57) ABSTRACT

An adjustable clamping device is provided. The adjustable clamping device includes: a clamping component, configured as a removable clamping object; and a support member, one end of which is movably connected to the clamping component. The support member has a first state in which angle support is formed with the clamping component and a second state in which the clamping component is attached, and the support member is rotated, so that the support member switches between the first state and the second state. According to the adjustable clamping device, angle support may be selectively formed with the clamping component by using the support member, thereby effectively solving a problem that an angle of an existing book clamping device cannot be adjusted.

### TECHNICAL FIELD

The present disclosure relates to the field of stationery technologies, and in particular, to an adjustable clamping device.

### BACKGROUND

During reading, a book page is easy to swing, especially in the wind, which affects reading efficiency and experience. As a result, many people solve this problem by holding book pages with clips. In addition, currently, desktops are basically horizontally set, and a physiological structure of a human body determines that a head needs to be lowered and eyes need to be look down a horizontal desktop. As a result, health problems such as cervical spondylosis, shortsightedness and humpback are easily caused. Therefore, an adjustable clamping device is provided to solve the problems.

### SUMMARY

An object of the present disclosure is to provide an adjustable clamping device, so as to solve a problem that an angle of an existing book clamping device cannot be adjusted.

The adjustable clamping device in the present disclosure may be implemented by using the following technical solutions.

The adjustable clamping device in the present disclosure includes: a clamping component, configured to detachably clamp an object; and a support member, one end of which is movably connected to the clamping component.

The support member has a first state in which angle support is formed with the clamping component and a second state in which the clamping component is attached, and the support member is rotated, so that the support member switches between the first state and the second state.

In one of implementations, the clamping component includes: a first clamping member and a second clamping member that are movably connected; and a clamping mechanism disposed between the first clamping member and the second clamping member, providing a clamping force for the first clamping member and the second clamping member.

In one of implementations, the support member is movably connected to the first clamping member. A first limit block and a second limit block are respectively disposed on the first clamping member. A first clamping part and a second clamping part are respectively disposed on the support member. The first clamping part cooperates with the first limit block, so that the support member remains in the first state. The second clamping part cooperates with the second limit block, so that the support member remains in the second state.

In one of implementations, a hinge slot is disposed on the first clamping member, and the first limit block and the second limit block are respectively disposed in the hinge slot.

In one of implementations, the clamping component further includes a fixed shaft. The fixed shaft is disposed in the hinged slot. One end of the support member is rotatably connected to the fixed shaft.

In one of implementations, the clamping component further includes a plurality of buffer pads, and the plurality of buffer pads are respectively disposed at opposite positions of the first clamping member and the second clamping member.

In one of implementations, accommodation cavities are disposed at opposite positions of the first clamping member and the second clamping member, and the buffer pad is fixedly disposed in the corresponding accommodation cavity.

In one of implementations, an avoidance hole is disposed at a position that is of the hinge slot and that is opposite to the second limit block.

In one of implementations, the first clamping member and the second clamping member are respectively provided with a plurality of anti-skid members at positions corresponding to grips.

In one of implementations, a first limit part is fixedly disposed on the first limit block, and the first limit part is detachably clamped with and connected to the support member, so that the support member remains in the first state. A first guide surface is disposed on one side of the first limit part.

In one of implementations, a second limit part is fixedly disposed on the second limit block, and the second limit part is detachably clamped with and connected to the support member, so that the support member remains in the second state. A second guide surface is disposed on one side of the second limit part.

In one of implementations, the clamping mechanism includes: a rotating shaft, which is disposed on the first clamping member and the second clamping member; and a torsional spring running through the rotating shaft, which is respectively in contact with and connected to the first clamping member and the second clamping member.

In one of implementations, the support member is rotatably connected, slidably connected or detachably connected to the clamping component.

In one of implementations, the support member includes: a hinge block, one end of which is rotatably connected to the clamping component; and a support block disposed at the other end of the hinge block.

In one of implementations, an accommodation slot is disposed on the hinge block, a through hole runs through the accommodation slot, and the first clamping part is disposed on a side edge of the through hole. The second clamping part is disposed on the hinge block and on another side opposite to the accommodation slot.

In one of implementations, the support member is integrally molded or assembled and molded with the hinge block.

In one of implementations, a plurality of support legs are disposed at one end that is of the support block and that is opposite to the hinge block.

Compared with the prior art, the adjustable clamping device in the present disclosure has following beneficial effects.

According to the adjustable clamping device according to the present disclosure, the movable support member is disposed on the clamping component, and the support member may selectively form angle support with the clamping component, so that an object clamped by the clamping component can form an angle with the desktop, and a reading angle that is more compatible with a physiological structure of a human body is provided, thereby facilitating a user to read, further alleviating cervical pressure, preventing humpback and shortsightedness, and effectively solving a problem that an angle of an existing book clamping device cannot be adjusted. In addition, by rotating the support member, the support member can be in a storage state relative to the clamping component, thereby reducing space occupied by the support member, and facilitating to perform storage and storage operations on the clamping device.

### BRIEF DESCRIPTION OF THE DRAWINGS

To describe the technical schemes in the embodiments of the present discourse more clearly, the following briefly describes the attached figures required for describing the embodiments. Apparently, the attached figures in the following descriptions show merely some embodiments of the present disclosure, and thus should not to be regarded as limitation of the scope; and a person of ordinary skill in the art may derive other attached figures from these attached figures without creative efforts.

FIG. 1 is a schematic diagram of a three-dimensional structure of an adjustable clamping device in a first use state according to the present disclosure, including a clamping component and a support member;

FIG. 2 is a schematic structural diagram of a longitudinal cross section of an adjustable clamping device in a first use state according to the present disclosure;

FIG. 3 is a schematic diagram of a three-dimensional structure of an adjustable clamping device in a second use state according to the present disclosure;

FIG. 4 is a schematic structural diagram of a longitudinal cross section of an adjustable clamping device in a second use state according to the present disclosure;

FIG. 5 is a schematic diagram of a three-dimensional structure of a clamping component shown in FIG. 1;

FIG. 6 is a schematic diagram of an enlarged structure of part A shown in FIG. 5;

FIG. 7 is a schematic diagram of an exploded structure of a clamping component shown in FIG. 1;

FIG. 8 is a schematic diagram of a three-dimensional structure of a support member shown in FIG. 1; and

FIG. 9 is a schematic diagram of a three-dimensional structure of a support member from another perspective shown in FIG. 1.

Reference signs in the figures: 1: clamping device; 10: clamping component; 11: first clamping member; 111: hinge slot; 112: first limit block; 1121: first limit part; 1122: first guide surface; 113: second limit block; 1131: second limit part; 1132: second guide surface; 1133: avoidance hole; 114: anti-skid member; 115: accommodation cavity; 12: second clamping member; 13: clamping mechanism; 131: rotating shaft; 132: torsional spring; 14: fixed shaft; 15: buffer pad; 20: support member; 21: hinge block; 211: rotating hole; 212: accommodation slot; 213: through hole; 214: first clamping part; 215: second clamping part; 2151: third guide surface; 22: support block; and 221: support leg.

### DETAILED DESCRIPTION OF THE EMBODIMENTS

To make the objectives, technical solutions, and advantages of the embodiments of the present disclosure clearer, the following clearly and completely describes the technical solutions in the embodiments of the present disclosure with reference to the attached figures in the embodiments of the present disclosure. Apparently, the described embodiments are some but not all of the embodiments of the present disclosure. Generally, the described and illustrated components of the embodiments of the present disclosure in the attached figures can be arranged and designed through various different configurations.

Therefore, the detailed description of the embodiments of the present disclosure provided in the attached figures is not intended to restrict the protected scope of the present disclosure, but merely represents the selected embodiment of the present disclosure. Based on the embodiment in the present disclosure, all other embodiments acquired by the ordinary technical staff in the art under the premise of without contributing creative labor belong to the scope protected by the present disclosure.

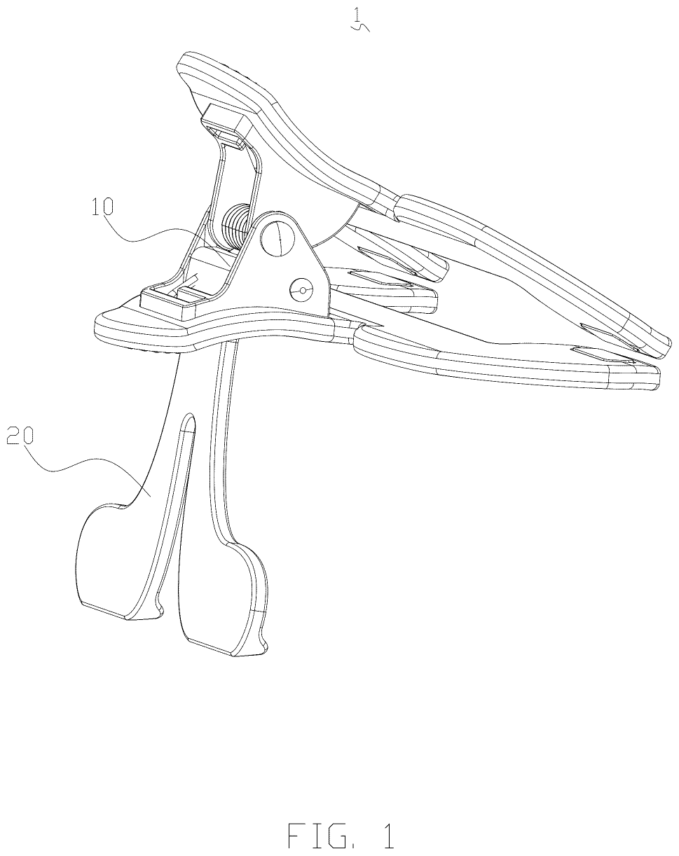

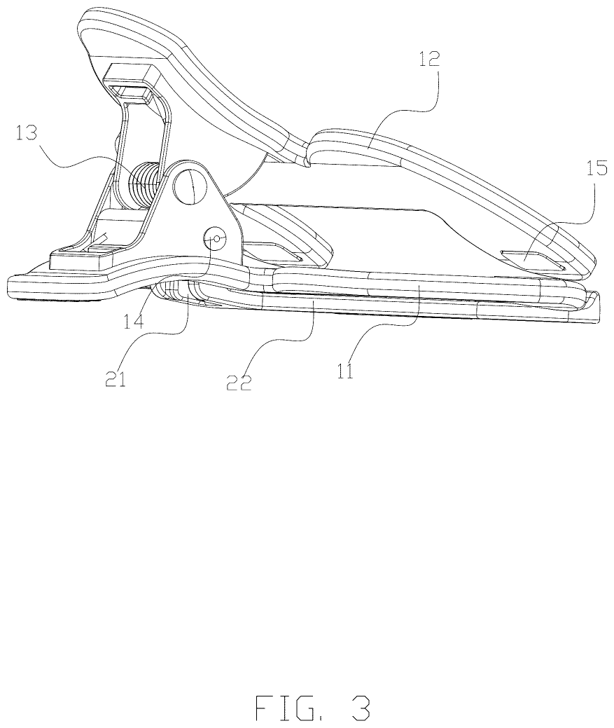

Referring to FIG. 1 to FIG. 9, an adjustable clamping device 1 according to the present disclosure includes a clamping component 10 and a support member 20. The clamping component 10 is configured to detachably clamp an object. One end of the support member 20 is movably connected to the clamping component 10, so that the support member 20 may form angle support with the clamping component 10 selectively, so that the clamped object forms an angle with the desktop and disposed obliquely on the desktop. A user reads the clamped object conveniently, which is more consistent with a physiological structure of the human body, thereby reducing an amplitude of lowering a head, alleviating cervical pressure, and preventing humpback and shortsightedness.

When in use, for example, when a book is read, the book is clamped by the clamping component 10, so as to prevent a book page from being tilted randomly. One end that is of the book and that is away from the user is raised by using the support member 20, so that a direction of the book is changed from a vertical horizontal direction to a user-oriented direction, so that the user can read the book without excessively lowering the head or even lowering the head. Similarly, when a tablet computer is read, the clamping component 10 may be sandwiched on the top of the tablet computer, and an inclination angle of the tablet computer is adjusted by using the support member 20, so that a screen of the tablet computer faces a direction of the user. Specifically, as long as the clamping component 10 has a function of clamping an object, this solution may be implemented. A structure of the clamping component 10 shown in the figure is not limited herein. A movable connection manner of the support member 20 includes but is not limited to a rotary connection, a sliding connection, or a detachable connection.

Specifically, the support member 20 is rotatably hinged on the clamping component 10. The support member 20 has a first state in which angle support is formed with the clamping component 10 and a second state in which the clamping component 10 is attached, and the support member 20 is rotated, so that the support member 20 can be switched between the first state and the second state.

In this embodiment, the angle between the clamped object and the desktop is determined by a length of the support member 20 or an angle between the support member 20 and the clamping component 10. Preferably, in this embodiment, the angle between the clamped object and the desktop is 12 degrees, and both reading and writing experience may be considered. In another embodiment, the angle between the clamped object and the desktop may be 2-89 degrees, and a preferred range value is 10-30 degrees, which may be implemented by assembling support members 20 of different lengths on the factory delivery of the clamping device 1.

Referring to FIG. 1 to FIG. 7, in this embodiment, the clamping component 10 includes a first clamping member 11, a second clamping member 12, a clamping mechanism 13, a fixed shaft 14, and a plurality of buffer pads 15. The first clamping member 11 and the second clamping member 12 are movably connected, and the second clamping member 12 can rotate relative to the first clamping member 11, so that the clamped object is conveniently placed between the first clamping member 11 and the second clamping member 12. The clamping mechanism 13 is disposed between the first clamping member 11 and the second clamping member 12, and provides a clamping force for the first clamping member 11 and the second clamping member 12. The fixed shaft 14 is disposed on the first clamping member 11, and one end of the support member 20 is rotatably connected to the fixed shaft 14, so that the support member 20 can perform a switching operation between the first state and the second state around the fixed shaft 14. The plurality of buffer pads 15 are respectively disposed at opposite positions of the first clamping member 11 and the second clamping member 12. By using the plurality of buffer pads 15, a rigid contact connection of the first clamping member 11 and the second clamping member 12 with the clamped object respectively is changed into a flexible contact connection, thereby effectively preventing the clamping component 10 from damaging the clamped object. Specifically, the buffer pad 15 is made of a flexible material. Preferably, the buffer pad 15 is made of a silicon film.

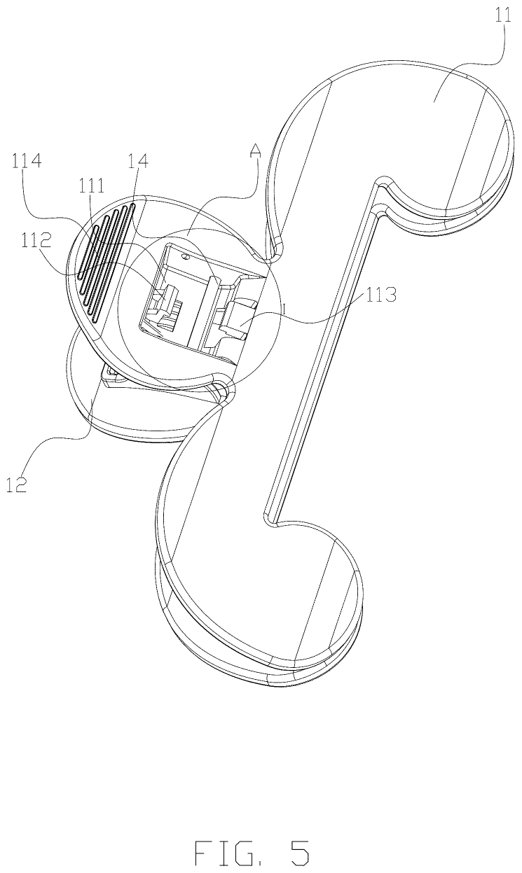

Referring to FIG. 5 to FIG. 7, in this embodiment, a hinge slot 111 is disposed on the first clamping member 11. The fixed shaft 14 is disposed in the hinge slot 111. One end of the support member 20 stretches into the hinge slot 111 to be rotatably connected to the fixed shaft 14. The first limit block 112 and the second limit block 113 are respectively disposed in the hinge slot 111. The first limit block 112 and the second limit block 113 respectively perform a limiting operation on the support member 20, so that the support member 20 remains in the first state or the second state. The first clamping member 11 and the second clamping member 12 are respectively provided with a plurality of anti-skid members 114 at positions corresponding to grips. A frictional force between fingers and the first clamping member 11 and the second clamping member 12 respectively is increased by using the plurality of anti-skid members 114, so that a sliding or separation operation between the fingers and the clamping component 10 is prevented. Accommodation cavities 115 are disposed at opposite positions of the first clamping member 11 and the second clamping member 12, and the buffer pad 15 is fixedly disposed in the corresponding accommodation cavity 115. In another embodiment, the first limit block 112 and the second limit block 113 may alternatively be disposed outside the hinge slot 111 and adjacent to the hinge slot 11.

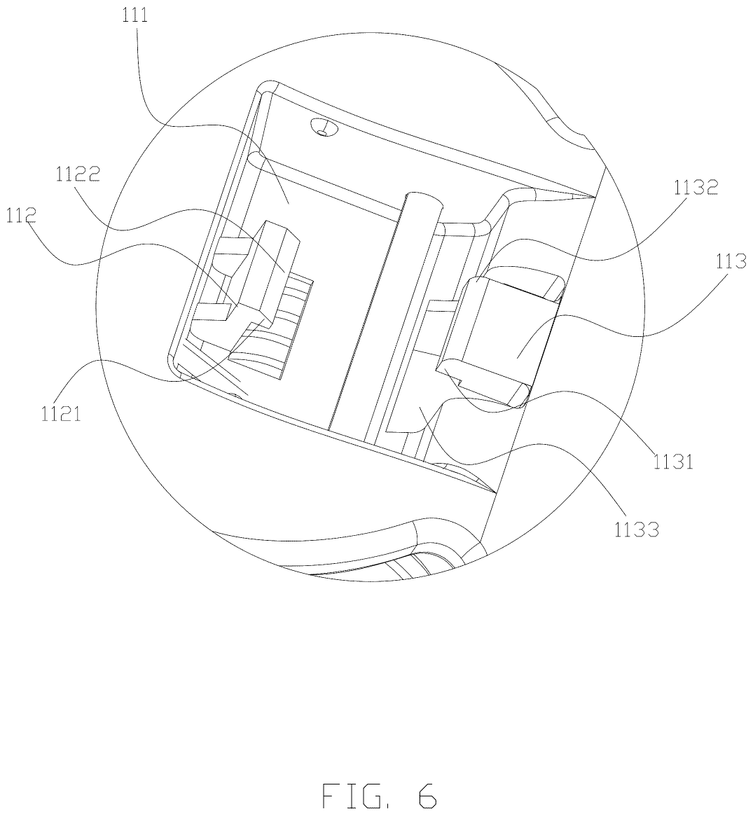

Referring to FIG. 5 and FIG. 6, specifically, a first limit part 1121 is fixedly disposed on the first limit block 112, and the first limit part 1121 is detachably clamped with and connected to the support member 20, so that the support member 20 remains in the first state. Preferably, the first limit part 1121 is a hook. A first guide surface 1122 is disposed on one side of the first limit part 1121. A guiding operation is performed on a movement of the support member 20 by using the first guide surface 1122, so that the first limit part 1121 is detachably clamped with and connected to the support member 20. Specifically, a second limit part 1131 is fixedly disposed on the second limit block 113, and the second limit part 1131 is detachably clamped with and connected to the support member 20, so that the support member 20 remains in the second state. Preferably, the second limit part 1131 is a fixture block. A second guide surface 1132 is disposed on one side of the first limit part 1131. A guiding operation is performed on the support member 20 by using the second guide surface 1132, so that the second limit part 1131 is detachably clamped with and connected to the movement of the support member 20. An avoidance hole 1133 is disposed in a position that is of the hinge slot 111 and that is opposite to the second limit block 113, and a limit clamping operation is performed on the support member 20 by using the avoidance hole 1133.

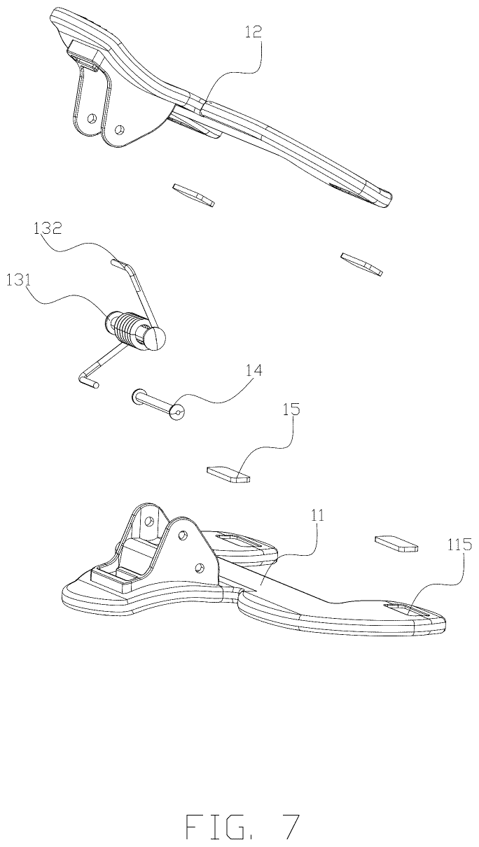

Referring to FIG. 7, in this embodiment, the clamping mechanism 13 includes a rotating shaft 131 and a torsional spring 132. The rotating shaft 131 is disposed on the first clamping member 11 and the second clamping member 12. The torsional spring 132 runs through the rotating shaft 131 and is connected to the first clamping member 11 and the second clamping member 12 in contact with each other respectively. The torsional spring 132 provides a clamping force for the first clamping member 11 and the second clamping member 12, so that the first clamping member 11 and the second clamping member 12 perform a clamping operation on the clamped object.

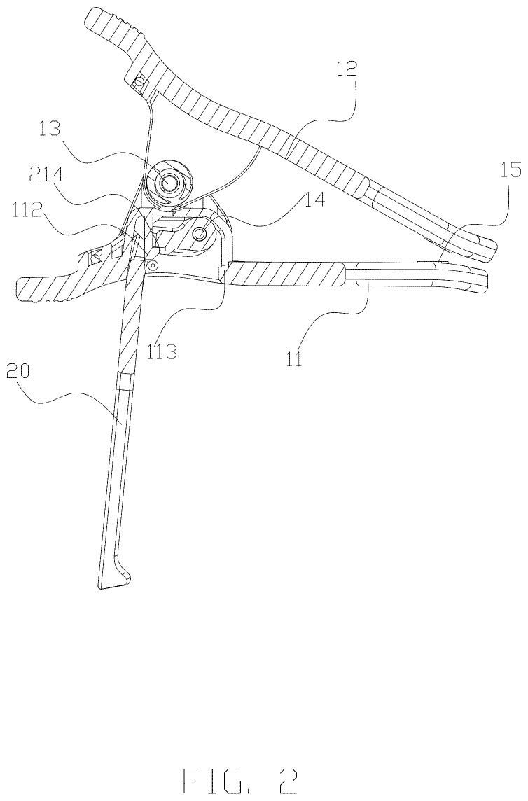

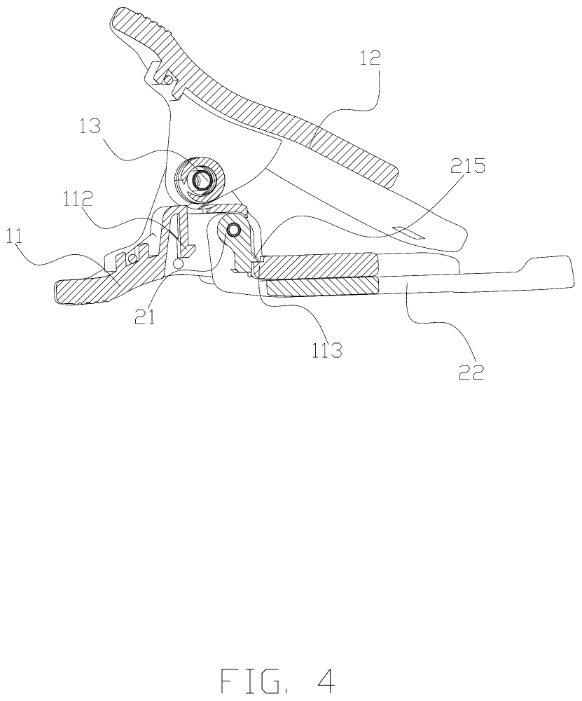

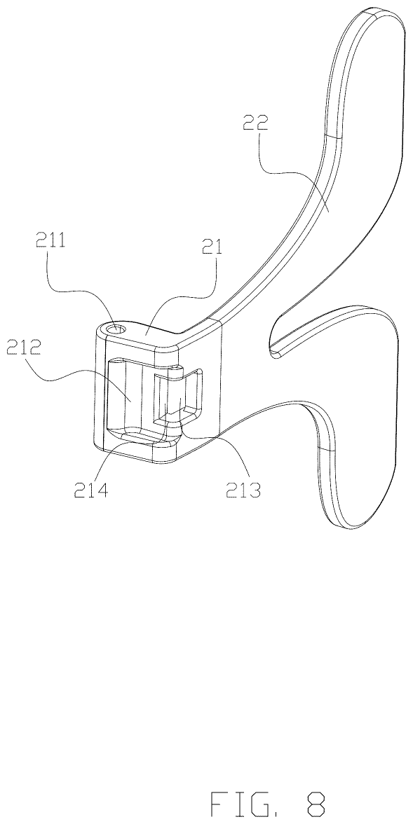

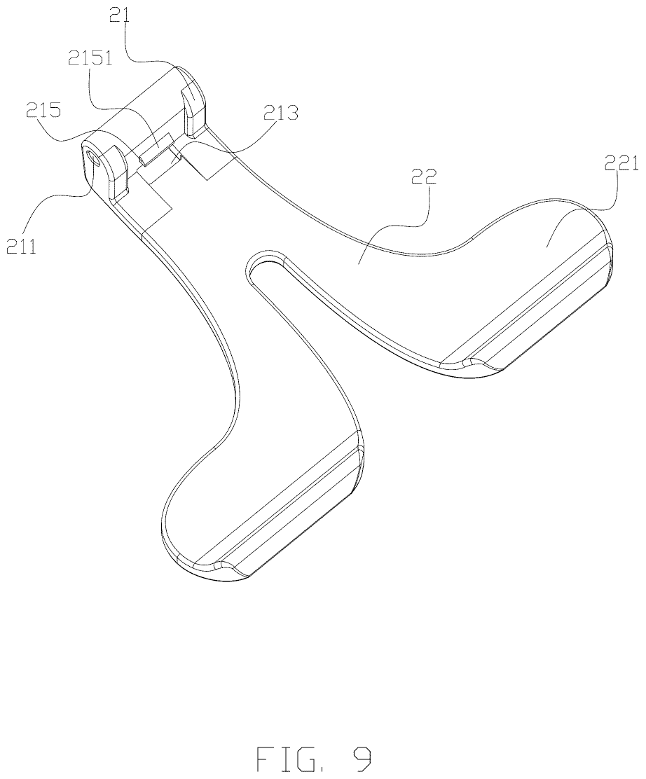

Referring to FIG. 2, FIG. 4, FIG. 8, and FIG. 9, in this embodiment, The support member 20 includes a hinge block 21 and a support block 22. One end of the hinge block 21 is movably hinged to the fixed shaft 14, so that the support member 20 can perform a rotating operation relative to the clamping component 10, so that the support member 20 performs the switching operation between the first state and the second state. The support block 22 is disposed on the other end of the hinge block 21, and a support operation is performed by using the support block 22.

Referring to FIG. 8 and FIG. 9, specifically, a rotating hole 211 runs through the hinge block 21, and the hinge block 21 is rotatably disposed on the fixed shaft 14 by using the rotating hole 211. An accommodation slot 212 is disposed on the hinge block 21. A first clamping part 214 needs to be disposed on a side of the through hole 213; and the first clamping part 214 cooperates with the first limit part 1121, so that the support member 20 remains in the first state. A second clamping part 215 is fixedly disposed on a side that is of the hinge block 21 and is opposite to the accommodation slot 212, and the second clamping part 215 cooperates with the second limit part 1131, so that the support member 20 remains in the second state. A third guide surface 2151 is disposed on the second clamping part 215, and a guiding operation in cooperation with the second limit block 113 is facilitated by using the third guide surface 2151.

Referring to FIG. 8 and FIG. 9, in this embodiment, the support block 22 and the hinge block 21 are integrally molded, and two support legs 221 are disposed at an end that is of the support block 22 and that is opposite to the hinge block 21, so as to increase a contact area with the desktop by using the two support legs 221, thereby improving support performance of the support block 22. In another embodiment, the support block 22 and the hinge block 21 may also be assembled and molded. A quantity of the support legs 221 may be three, four, or others, and the quantity of the support legs 221 may be set according to an actual requirement.

In some embodiments, the adjustable clamping device 1 according to the present disclosure may also adjust the angle between the clamped object and the desktop by setting a plurality of groups of the support members 20, thereby meeting requirements of different users or a same user for use in different scenarios. Specifically, several or several groups of support members 20 are provided. The support members 20 may be connected to each other in a nested distribution manner or arranged distribution manner, and are respectively movably connected to, preferably connected to, the clamping component 10. Lengths of different support members 20 are different, or lengths of support members 20 of different groups are different. Different support members 20 are selected by the user, so that the object clamped by the book clamping device have different inclination angles with the desktop, thereby further optimizing product use experience.

In some embodiments, the adjustable clamping device 1 according to the present disclosure may also adjust the angle between the clamped object and the desktop by setting a plurality of groups of the support members 20, thereby meeting requirements of different users or a same user for use in different scenarios. Specifically, the support member 20 is a member with a stretchable length, or the support member 20 is a foldable storage member. The length of the support member 20 is changed by using the telescopic support member 20 or folding a part of the support member 20, so as to adjust an angle between the clamped object and the desktop.

In some embodiments, in the adjustable clamping device 1 according to the present disclosure, the movable connection between the support member 20 and the clamping component 10 is a detachable pluggable connection or a sliding connection. The support member 20 is assembled to the clamping component 10. To correspond to the first state, the clamped object can be disposed on the desktop slantly. The support member 20 is detached from the clamping component 10, which corresponds to the second state. Specifically, the support member 20 and the clamping component 10 are detachably connected by using an installation block and an installation slot. For example, the installation block is disposed on the support member 20, and the installation slot is disposed on the clamping component 10. The installation block is inserted with and cooperates with the installation slot, or a channel is disposed in the installation slot, and the installation block is assembled to the installation slot, and can slide along the channel, so that the support member 20 can be assembled to the clamping component 10 as required.

It should be noted that a specific working process of the adjustable clamping device 1 according to the present disclosure is as follows. By using the movable support member 20 disposed on the clamping component 10, the support member 20 may selectively form angle support with the clamping component 10, so that the support member 20 is in a support state, and the object clamped by the clamping component 10 can form an angle with the desktop, and a reading angle that is more compatible with a physiological structure of a human body is provided, thereby facilitating a user to read, further alleviating cervical pressure, and preventing humpback and shortsightedness. In addition, the support member 20 may also be rotated, so that the support member 20 is in a storage state, thereby facilitating to perform storage and storage operations on the clamping device 1.

The technical features of the above-mentioned embodiments may be arbitrarily combined, and all possible combinations of the technical features in the above-mentioned embodiments are not described for simplicity of description. However, as long as the combinations of the technical features do not contradict one another, the technical features should be considered to be within the scope of the description of the present disclosure.

The above embodiments only express several embodiments of the present disclosure, and the description is specific and detailed, but cannot be construed as limiting the claims of the present disclosure. It should be noted that several modifications and improvements may also be made to those skilled in the art without departing from the inventive concept, which fall within the scope of the present disclosure. Therefore, the protection scope of the present disclosure shall be subject to the protection scope of the claims.

What is claimed is:

1. An adjustable clamping device, comprising:
a clamping component, configured to detachably clamp an object; and
a support member, one end of which is movably connected to the clamping component; wherein
the support member has a first state in which angle support is formed with the clamping component and a second state in which the clamping component is attached, and the support member is rotated, so that the support member switches between the first state and the second state.

2. The adjustable clamping device according to claim 1, wherein the clamping component comprises: a first clamping member and a second clamping member that are movably connected; and a clamping mechanism disposed between the first clamping member and the second clamping member, providing a clamping force for the first clamping member and the second clamping member.

3. The adjustable clamping device according to claim 2, wherein the support member is movably connected to the first clamping member; and a first limit block and a second limit block are respectively disposed on the first clamping member; a first clamping part and a second clamping part are respectively disposed on the support member; the first clamping part cooperates with the first limit block, so that the support member remains in the first state; and
the second clamping part cooperates with the second limit block, so that the support member remains in the second state.

4. The adjustable clamping device according to claim 3, wherein a hinge slot is disposed on the first clamping member, and the first limit block and the second limit block are respectively disposed in the hinge slot.

5. The adjustable clamping device according to claim 4, wherein the clamping component further comprises a fixed shaft, the fixed shaft is disposed in the hinged slot, and one end of the support member is rotatably connected to the fixed shaft.

6. The adjustable clamping device according to claim 5, wherein the clamping component further comprises a plurality of buffer pads, and the plurality of buffer pads are respectively disposed at opposite positions of the first clamping member and the second clamping member.

7. The adjustable clamping device according to claim 6, wherein accommodation cavities are disposed at opposite positions of the first clamping member and the second clamping member, and the buffer pad is fixedly disposed in the corresponding accommodation cavity.

8. The adjustable clamping device according to claim 4, wherein an avoidance hole is disposed in a position that is of the hinge slot and that is opposite to the second limit block.

9. The adjustable clamping device according to claim 2, wherein the first clamping member and the second clamping member are respectively provided with a plurality of anti-skid members at positions corresponding to grips.

10. The adjustable clamping device according to claim 3, wherein a first limit part is fixedly disposed on the first limit block, and the first limit part is detachably clamped with and connected to the support member, so that the support member remains in the first state; and a first guide surface is disposed on one side of the first limit part.

11. The adjustable clamping device according to claim 3, wherein a second limit part is fixedly disposed on the second limit block, and the second limit part is detachably clamped with and connected to the support member, so that the support member remains in the second state; and a second guide surface is disposed on one side of the second limit part.

12. The adjustable clamping device according to claim 2, wherein the clamping mechanism comprises: a rotating shaft, which is disposed on the first clamping member and the second clamping member; and a torsional spring running through the rotating shaft, which is respectively in contact with and connected to the first clamping member and the second clamping member.

13. The adjustable clamping device according to claim 3, wherein the support member is rotatably connected, slidably connected or detachably connected to the clamping component.

14. The adjustable clamping device according to claim 13, wherein the support member comprises: a hinge block, one end of which is rotatably connected to the clamping component; and a support block disposed at the other end of the hinge block.

15. The adjustable clamping device according to claim 14, wherein an accommodation slot is disposed on the hinge block, a through hole runs through the accommodation slot, and the first clamping part is disposed on a side of the through hole; and the second clamping part is disposed on the hinge block and on another side opposite to the accommodation slot.

16. The adjustable clamping device according to claim 14, wherein the support member is integrally molded or assembled and molded with the hinge block.

17. The adjustable clamping device according to claim 14, wherein a plurality of support legs are disposed at one end that is of the support block and that is opposite to the hinge block.
